(19) United States
(12) Patent Application Publication
(10) Pub. No.: US 2010/0266160 A1
(43) Pub. Date: Oct. 21, 2010

(54) Image Sensing Apparatus And Data Structure Of Image File

(75) Inventor: Akihiko YAMADA, Osaka (JP)

Correspondence Address: NDQ&M WATCHSTONE LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/732,325

(22) Filed: Mar. 26, 2010

(30) Foreign Application Priority Data
Apr. 20, 2009 (JP) 2009101881

(51) Int. Cl. H04N 5/232; G06K 9/00

(52) U.S. Cl. 382/103; 348/211.99; 348/E05.042

(57) ABSTRACT

An image sensing apparatus includes an image sensing portion which generates image data of an image by image sensing, and a record control portion which records image data of a main image generated by the image sensing portion together with main additional information obtained from the main image in a recording medium, in which the record control portion records sub additional information obtained from a sub image taken at a timing different from that of the main image in the recording medium in association with the image data of the main image and the main additional information.

### CROSS-REFERENCE TO RELATED APPLICATIONS

This nonprovisional application claims priority under 35 U.S.C. § 119(a) on patent application No. 2009-101881 filed in Japan on Apr. 20, 2009, the entire contents of which are hereby incorporated by reference.

### BACKGROUND OF THE INVENTION

1. Field of the Invention

The present invention relates to an image sensing apparatus such as a digital camera. In addition, the present invention relates to a data structure of an image file.

2. Description of Related Art

Recent years, as large-capacity recording media have become available, it is possible to record a large volume of images in a recording medium. Therefore, it is demanded to provide a search method or a classification method for finding a desired image efficiently from a large volume of images.

In view of this, a certain conventional method uses information generated when a target image is taken, so as to add classification information that is suitable for image classification to the target image. When the image is reproduced, the classification information is used so that a desired image can be found easily.

However, the above-mentioned conventional method uses only information at sensing time of the target image itself when looking for or classifying the target image. Therefore, an increase in efficiency of search or classification is limited.

### SUMMARY OF THE INVENTION

An image sensing apparatus according to the present invention includes an image sensing portion which generates image data of an image by image sensing, and a record control portion which records image data of a main image generated by the image sensing portion together with main additional information obtained from the main image in a recording medium, in which the record control portion records sub additional information obtained from a sub image taken at a timing different from that of the main image in the recording medium in association with the image data of the main image and the main additional information.

In a data structure of an image file according to the present invention, image data of a main image obtained by image sensing, main additional information obtained from the main image, and sub additional information obtained from a sub image taken before the main image are stored in association with each other.

Meanings and effects of the present invention will be further clarified from the following description of an embodiment. However, the following embodiment is merely one of embodiments of the present invention, and meanings of the present invention and individual elements are not limited to those described in the following embodiment.

### BRIEF DESCRIPTION OF THE DRAWINGS

FIG. 1 is a block diagram illustrating a structure of an image sensing apparatus according to an embodiment of the present invention.

FIG. 2 is an inner structural diagram of an image sensing portion illustrated in FIG. 1.

FIG. 3 is a diagram illustrating a structure of an image file to be recorded in a recording medium.

FIG. 4 is a diagram illustrating a main input image, main tag information and an image file assumed in a specific example of an embodiment of the present invention.

FIG. 5 is a diagram illustrating a sub input image, a main input image, a main tag information and sub tag information assumed in a specific example of an embodiment of the present invention.

FIG. 6 is a diagram illustrating a first photographing timing relationship between the sub input image and the main input image.

FIG. 7 is a diagram illustrating a manner in which an AF evaluation region is set in a preview image.

FIG. 8 is a diagram illustrating a second photographing timing relationship between the sub input image and the main input image.

FIG. 9 is a diagram illustrating a third photographing timing relationship between the sub input image and the main input image.

FIG. 10 is a diagram illustrating a fourth photographing timing relationship between the sub input image and the main input image.

FIG. 11 is an operational flowchart of the image sensing apparatus illustrated in FIG. 1 concerning an operation for creating the image file.

### DETAILED DESCRIPTION OF THE PREFERRED EMBODIMENTS

Hereinafter, an embodiment of the present invention will be described in specifically with reference to the drawings. In the drawings to be referred to, the same part is denoted by the same reference numeral so that overlapping description of the same part is omitted in principle.

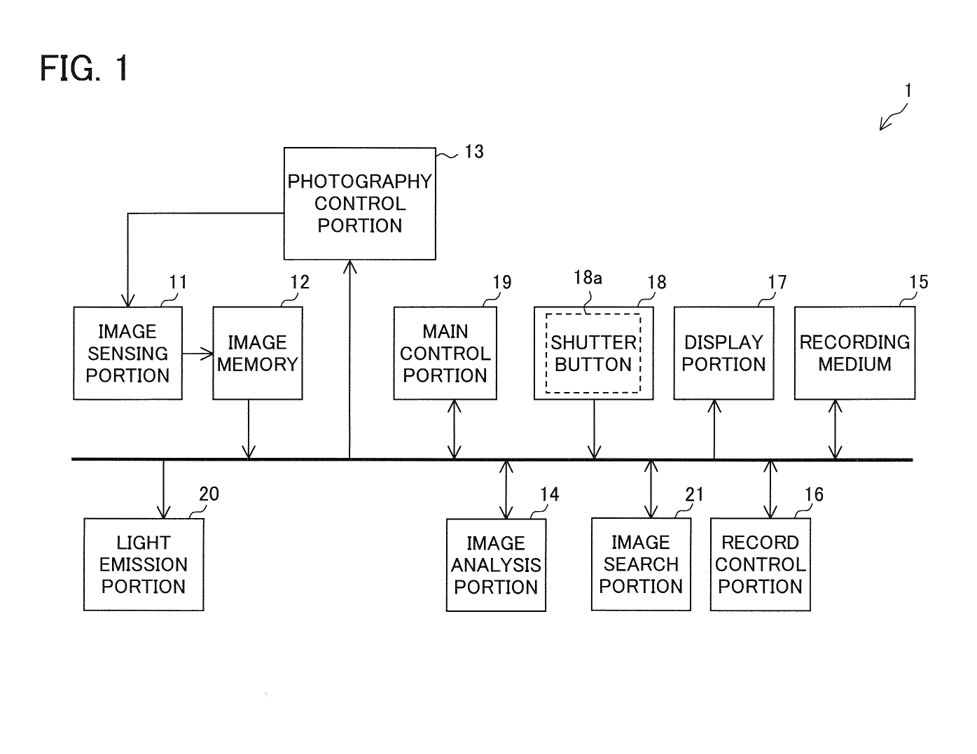

FIG. 1 is a block diagram illustrating a structure of an image sensing apparatus 1 according to an embodiment of the present invention. The image sensing apparatus 1 includes individual portions denoted by numerals 11 to 21. The image sensing apparatus 1 is a digital video camera capable of taking still images and moving images. However, the image sensing apparatus 1 may be a digital still camera capable of taking only still images.

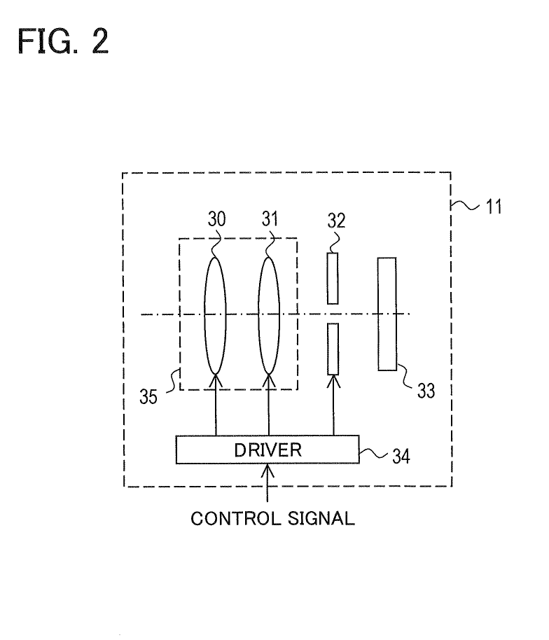

The image sensing portion 11 obtains image data of a subject image by shooting a subject with an image sensor. FIG. 2 is an inner structural diagram of the image sensing portion 11. The image sensing portion 11 includes an optical system 35, an iris stop 32, an image sensor (solid-state image sensor) 33 constituted of a CCD (Charge Coupled Device) or a CMOS (Complementary Metal Oxide Semiconductor) image sensor or the like, a driver 34 for drive control of the optical system 35 and the iris stop 32. The optical system 35 is constituted of a plurality of lenses including a zoom lens 30 for adjusting an angle of view of the image sensing portion 11 and a focus lens 31 for focus operation. The zoom lens 30 and the focus lens 31 can move in the optical axis direction.

The image sensor 33 performs photoelectric conversion of an optical image representing the subject that enters through the optical system 35 and the iris stop 32, and outputs an analog electric signal obtained by the photoelectric conversion. An analog front end (AFE) that is not illustrated amplifies the analog signal output from the image sensor 33 and converts the amplified signal into a digital signal. The obtained digital signal is recorded as image data of the subject image in an image memory 12 constituted of SDRAM (Synchronous Dynamic Random Access Memory) or the like.

Hereinafter, an image of one frame expressed by image data of one frame period recorded in the image memory 12 will be referred to as a frame image. Note that image data may be simply referred to as an image in this specification.

The image data of the frame image is sent as image data of the input image to a necessary portion (e.g., an image analysis portion 14) in the image sensing apparatus 1. In this case, it is possible to adopt a structure in which necessary image processing (noise reduction, edge enhancement, or the like) is performed on the image data of the frame image, and the image data after the image processing is sent as image data of the input image to the image analysis portion 14 and the like.

A photography control portion 13 outputs a control signal for adjusting appropriately positions of the zoom lens 30 and the focus lens 31 as well as an open degree of the iris stop 32 to the driver 34 (see FIG. 2). Based on this control signal, the driver 34 performs drive control of the positions thereof and the open degree, so that an angle of view (focal length) and a focal position of the image sensing portion 11 and incident light quantity to the image sensor 33 are adjusted.

The image analysis portion 14 detects a specific type of subject included in the input image based on the image data of the input image.

The specific type of subject includes a face of a person or a whole body of a person. The image analysis portion 14 detects a face and a person in the input image by a face detection process. In the face detection process, a face region that is a region including a face portion of a person is detected and extracted from the image region of the input image based on the image data of the input image. If p face regions are extracted from a certain input image, the image analysis portion 14 decides that p faces exist in the input image or that p persons exist in the input image (p is a natural number). The image analysis portion 14 can perform the face detection process by an arbitrary method including a known method. Further, hereinafter, an image in the face region extracted by the face detection process is also referred to as an extracted face image.

In addition, it is possible to form the image analysis portion 14 so that the face recognition process can be performed. In the face recognition process, it is discriminated which person among one or more pre-enrolled persons the person having the face extracted from the input image by the face detection process is. Various methods are known as the method of the face recognition process, so that the image analysis portion 14 can perform the face recognition process by an arbitrary method including a known method.

For instance, it is possible to perform the face recognition process based on image data of the extracted face image and a face image database for matching. The face image database stores image data of face images of different enrolled persons. The face image database may be installed in the image analysis portion 14 in advance. A face image of an enrolled person stored in the face image database is referred to as an enrolled face image. Similarity evaluation between the extracted face image and enrolled face images based on image data of the extracted face image and image data of the enrolled face image is performed for each enrolled face image, so that the face recognition process can be realized.

Note that it is possible to estimate gender, race, age bracket and the like of the person corresponding to the extracted face image based on the image data of the extracted face image. As this estimation method, any method such as a known method (e.g., a method described in JP-A-2004-246456, JP-A-2005-266981 or JP-A-2003-242486) can be utilized.

Further, the image analysis portion 14 can detect a specific type of subject other than a face or a person existing in the input image based on the image data of the input image. A process for performing this detection is referred to as an object detection process for convenience sake. If the object to be detected is considered to be a face or a person, the object detection process is the face detection process.

A type of the subject to be detected in the object detection process can be any type. For instance, a vehicle, a tree, a tall building, and the like in the image can be detected on the object detection process. In order to detect a vehicle, a tree, a building, and the like in the image, it is possible to use an edge detection, a contour detection, an image matching, a pattern recognition and other various image processing, and to use any method including a known method. For instance, if the specific type of subject is a vehicle, the vehicle in the input image can be detected by detecting wheel tires in the input image based on the image data of the input image or by image matching between the image data of the input image and prepared image data of a vehicle image.

Further, the image analysis portion 14 can detect an image feature of the input image based on the image data of the input image. The process for performing the detection is referred to as an image feature detection process. In the image feature detection process, for example, it can be detected based on a luminance level of the input image whether the input image is taken in a dark place or a bright place or in a backlight situation.

Hereinafter, the process including the face detection process, the face recognition process, the process of estimating gender, race and age bracket of a person, the object detection process, and the image feature detection process is referred to as an image analysis collectively.

The recording medium 15 is a nonvolatile memory constituted of a magnetic disk, a semiconductor memory, or the like. The image data of the input image may be contained in the image file and stored in the recording medium 15.

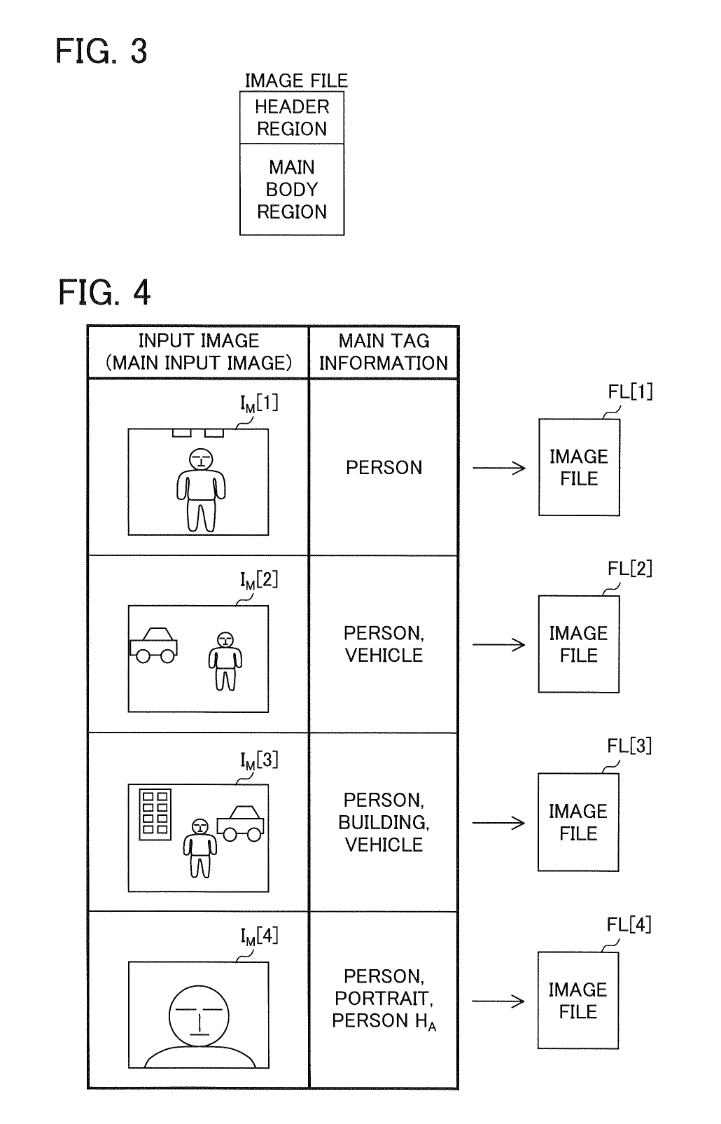

FIG. 3 illustrates a structure of one image file. One image file is generated for one still image or moving image. The structure of the image file can adhere to any standard. The image file is constituted of a main body region in which image data of the still image or the moving image is stored and a header region in which additional information is stored. In this example, the main body region stores the image data of the input image as it is or compressed data of the image data of the input image. Note that “data” and “information” have the same meaning in this specification.

The main body region and the header region in one image file are recording regions that are associated with each other as a matter of course. Therefore, data stored in the main body region and data stored in the header region of the same image file are naturally associated with each other. The additional information to be stored in the header region will be described later in detail.

The record control portion 16 performs various necessary record controls for recording data in the recording medium 15. The display portion 17 is constituted of a liquid crystal display or the like and displays the input image obtained by the image sensing portion 11 or the image recorded in the recording medium 15. The operating portion 18 is a portion for a user to perform various operations on the image sensing apparatus 1. The operating portion 18 includes a shutter button 18a for issuing an instruction to take a still image and a record button (not shown) for issuing instructions to start and stop recording a moving image. The main control portion 19 integrally controls operations of the individual portions in the image sensing apparatus 1 in accordance with a content of the operation performed with the operating portion 18. The light emission portion 20 is a light emission device having a xenon tube or a light emission diode as a light source and projects flash light generated by the light source to the subject if necessary at a timing instructed by the photography control portion 13 in accordance with a press timing of the shutter button 18a.

The image search portion 21 searches a lot of image files recorded in the recording medium 15 so as to find an image file satisfying a specific condition. A result of the search is reflected on display contents of the display portion 17. The image search portion 21 has a plurality of search modes including a normal search mode. The search mode that is actually performed is specified in accordance with the operation content to the operating portion 18.

With reference to FIG. 4, the normal search mode will be described. It is supposed that four input images I_{M}[1] to I_{M}[4] as four still images are obtained by the image sensing portion 11 in accordance with the press operation of the shutter button 18a. In this case, the record control portion 16 generates four image files FL[1] to FL[4] in the recording medium 15, so as to record image data of input images I_{M}[1] to I_{M}[4] in the main body regions of the image files FL[1] to FL[4], respectively. Note that the input image whose image data is recorded in the main body region of the image file is also referred to as a main input image in particular. The press operation of the shutter button 18a is an operation of instruction to take a still image as a main input image.

On the other hand, the image analysis portion 14 performs the image analysis on each of the input images I_{M}[1] to I_{M}[4]. The record control portion 16 records information obtained by the image analysis performed on the input image I_{M}[i] as main tag information in the header region of the image file FL[i]. Here, i denotes a natural number. Therefore, the main tag information obtained by the image analysis on the input image I_{M}[1] is recorded in the header region of the image file FL[1], and the main tag information obtained by the image analysis on the input image I_{M}[2] is recorded in the header region of the image file FL[2] (the same is true for the input images I_{M}[3] and I_{M}[4]). Note that, in the header region of the image file FL[i], not only the main tag information of the input image I_{M}[i] but also information indicating photography time of day of the input image I_{M}[i], image data of a thumbnail image of the input image I_{M}[i], and other various pieces of information about the input image I_{M}[i] are recorded.

In the following description, it is supposed that subjects of the image sensing apparatus 1 include only person, building, tree and vehicle for a simple description (i.e., a subject other than person, building, tree and vehicle is ignored). In addition, it is supposed that image files record in the recording medium 15 are only image files FL[1] to FL[4].

It is supposed that subjects of the input image I_{M}[1] include only person, subjects of the input image I_{M}[2] include only person and vehicle, subjects of the input image I_{M}[3] include only person, building and vehicle, and subjects of the input image I_{M}[4] include only person.

The record control portion 16 writes a type of a subject detected by image analysis on the input image I_{M}[i] in the main tag information of the input image I_{M}[i]. Therefore, only “person” is written in the main tag information of the input image I_{M}[1], only “person” and “vehicle” are written in the main tag information of the input image I_{M}[2], only “person”, “building” and “vehicle” are written in the main tag information of the input image I_{M}[3], and “person” as well as “portrait” are written in the main tag information of the input image I_{M}[4].

The image analysis portion 14 decides that an input image of interest is a portrait image if a ratio of an extracted face region in the entire image region of the input image of interest is a predetermined reference ratio or larger. Since the input image I_{M}[4] is decided to be a portrait image, the record control portion 16 writes “portrait” in the main tag information of the input image I_{M}[4] in accordance with a result of the decision.

In addition, it is supposed that the person included in the input image I_{M}[4] is detected to be an enrolled person H_{A} by the face recognition process. In this case, the record control portion 16 writes “person H_{A}” in the main tag information of the input image I_{M}[4].

An operation of the normal search mode will be described in the state where the image files FL[1] to FL[4] storing individual image data of the input image and the main tag information are recorded in the recording medium 15. When the user sets a search condition in the image sensing apparatus 1, search of image files is performed in accordance with the search condition. The search condition is set by specifying a search term. The search term is specified by an operation to the operating portion 18, for example. If the display portion 17 has a so-called touch panel function, it is possible to use the function for specifying the search term. The user can specify the search term by inputting characters one by one or by selecting a search term from a plurality of prepared candidate terms.

In the normal search mode, the image search portion 21 takes each of the image files FL[1] to FL[4] as an image file of interest. Then, if the main tag information of the image file of interest includes a term that matches (or substantially matches) with the search term specified by the search condition, the image file of interest is selected as a retrieved file. After the retrieved file is selected, the image search portion 21 displays information about the retrieved file on the display portion 17. This information may be displayed in any form. For instance, a name of the image file selected as a retrieved file and/or an image based on the image data in the image file selected as a retrieved file (e.g., a thumbnail image) may be displayed on the display portion 17.

In the normal search mode,

if “person” is specified as the search term, the image files FL[1] to FL[4] are selected as the retrieved files;

if “vehicle” is specified as the search term, only the image files FL[2] and FL[3] are selected as the retrieved files;

if “building” is specified as the search term, only the image file FL[3] is selected as the retrieved file;

if “portrait” is specified as the search term, only the image file FL[4] is selected as the retrieved file; and

if “person H_{A}” is specified as the search term, only the image file FL[4] is selected as the retrieved file.

In addition, a plurality of search terms may be specified in the search condition. For instance, if the condition that a first search term “vehicle” and a second search term “building” are both included in the main tag information is set as the search condition, only the image file FL[3] is selected as the retrieved file. Further, for example, if the condition that a first search term “vehicle” or a second search term “building” is included in the main tag information is set as the search condition, the image files FL[2] and FL[3] are selected as the retrieved files.

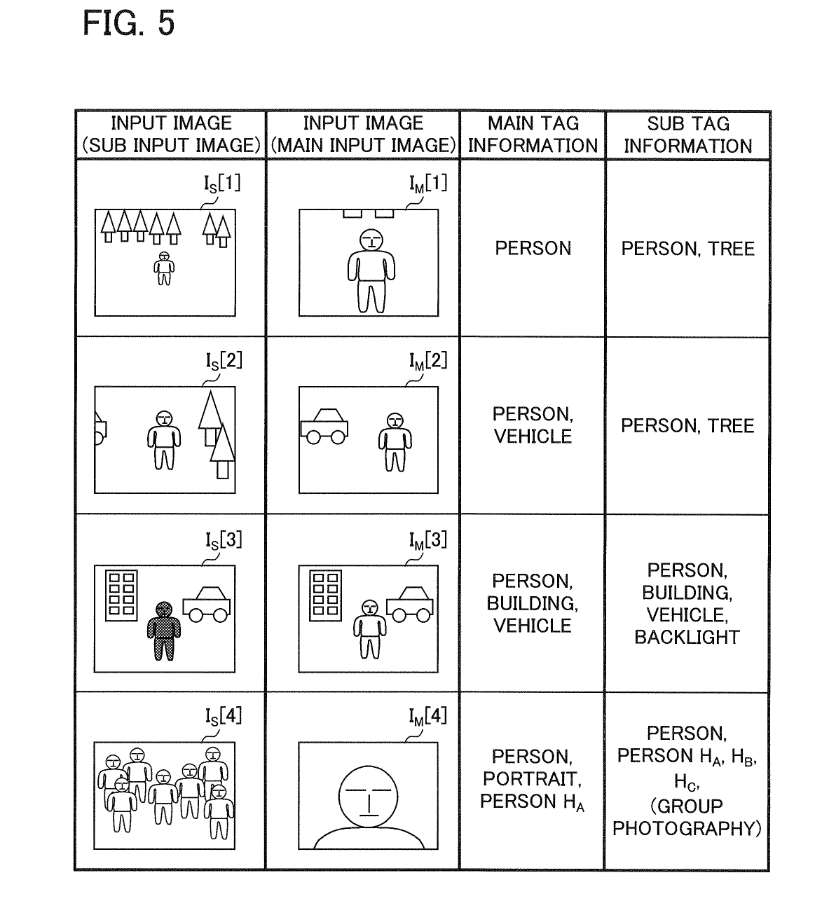

Next, with reference to FIG. 5, a generation method of sub tag information that is used in an extended search mode as one of search modes of the image search portion 21 will be described. In the extended search mode, besides the main tag information obtained from the input images I_{M}[1] to I_{M}[4] as the main input images, the sub tag information obtained from the input image taken before the main input image is utilized. The input image that is taken for obtaining the sub tag information before the main input image is also referred to as a sub input image. The main input image and the sub input image are considered to be related to each other closely. By using both the main tag information obtained from the main input image and the sub tag information obtained from the sub input image, a desired image file can be retrieved easily. The search operation in the extended search mode is similar to that in the normal search mode. The search operation in the extended search mode will be described later, and before that a method of obtaining the sub input image and the generation method of the sub tag information will be described first.

The sub input images for the main input images I_{M}[1] to I_{M}[4] are denoted by symbols I_{S}[1] to I_{S}[4], respectively. The image analysis portion 14 performs the image analysis on each of the sub input images I_{S}[1] to I_{S}[4]. The record control portion 16 records the information obtained by the image analysis on the sub input image I_{S}[i] in the header region of the image file FL[i] as the sub tag information. Here, “i” denotes a natural number. Therefore, the sub tag information obtained by the image analysis on the sub input image I_{S}[1] is recorded in the header region of the image file FL[1], and the sub tag information obtained by the image analysis on the sub input image I_{S}[2] is recorded in the header region of the image file FL[2] (the same is true for the sub input images I_{S}[3] and I_{S}[4]). By performing such record, the image data of the main input image I_{M}[1] and the main tag information and the sub tag information obtained from the main input image I_{M}[1] and the sub input image I_{S}[1] are associated with each other in the recording medium 15.

The image sensing portion 11 performs image sensing of the input images (frame images) periodically at a predetermined frame period (e.g., 1/30 seconds), and the input images obtained sequentially are updated and displayed on the display portion 17 (i.e., a set of the input images obtained sequentially are displayed as a moving image on the display portion 17). The user views contents of the display so as to confirm a range of image taken by the image sensing portion 11 and issues an exposure instruction of a still image by a pressing operation of the shutter button 18a at a desired timing. Just after the exposure instruction, the main input image is generated based on the image data obtained from the image sensing portion 11. Input images other than the main input image works as image for confirming a range of image sensing, and input images other than the main input image are also referred to as preview images. The sub input image is any one of preview images taken before sensing the main input image. Note that image resolution may be different between the main input image and the preview image.

Hereinafter, as first to fourth specific examples, photographing timing and the like of the sub input images I_{S}[1] to I_{S}[4] will be described for each sub input image.

### FIRST SPECIFIC EXAMPLE

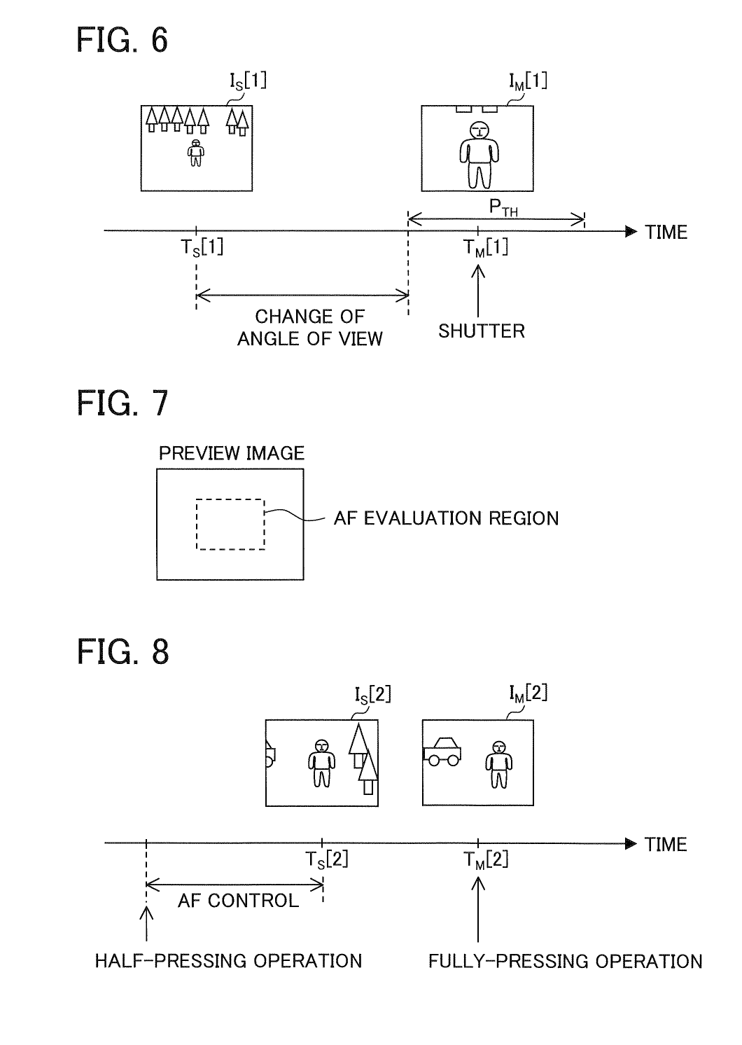

First, with reference to FIG. 6, a first specific example corresponding to I_{S}[1] and I_{M}[1] will be described. In the first specific example, it is supposed that an angle of view of the image sensing portion 11 is changed between the photographing timing of the sub input image and the photographing timing of the main input image. In accordance with a predetermined zoom magnification change operation to the operating portion 18, the photography control portion 13 moves the zoom lens 30 in the optical system 35 so as to change the angle of view of the image sensing portion 11 (see FIG. 2).

The photographing timings of the input images I_{S}[1] and I_{M}[1] are denoted by symbols T_{S}[1] and T_{M}[1], respectively. The photographing timing T_{S}[l] is timing before the photographing timing T_{M}[1]. The photographing timing of the input image of interest means a start time point of the exposure period of the image sensor 33 for obtaining image data of the input image of interest, for example.

When the angle of view of the image sensing portion 11 is changed prior to exposure of the main input image I_{M}[1], the input image based on the image data obtained from the image sensing portion 11 before the change (preview image) is handled as the sub input image I_{S}[1].

Specifically, the following process is performed. When the zoom magnification change operation for instructing to change the angle of view of the image sensing portion 11 is performed, the timing just before changing the angle of view actually is handled as the photographing timing T_{S}[1], and the input image taken at the photographing timing T_{S}[1] is handled as the sub input image I_{S}[1]. Further, information Q_{S}[1] indicating a result of the image analysis on the sub input image I_{S}[1] is temporarily record in a memory (not shown) provided to the record control portion 16 or the like.

After that, if a press operation of the shutter button 18a is performed in a predetermined period P_{TH} after the angle of view is changed and is fixed, the timing just after the press operation is handled as the photographing timing T_{M}[1] so as to take the main input image I_{M}[1]. After this image sensing, the record control portion 16 records the image data and the main tag information of the main input image I_{M}[1] and the sub tag information based on the information Q_{S}[1] in the image file FL[1].

Note that if the press operation of the shutter button 18a is performed after a period longer than the period P_{TH} has passed after the angle of view is fixed, it is expected that there is little relevance between the input images I_{M}[1] and I_{S}[1]. Therefore, in this case the sub tag information obtained from the sub input image I_{S}[1] may not be recorded (or may be recorded) in the image file FL[1].

The sub input image I_{S}[1] is an image that is taken with a relatively large angle of view, while the main input image I_{M}[1] is an image that is taken with a relatively small angle of view. In this case, the sub input image I_{S}[1] may include peripheral subjects around the subject of interest (the person in this example) that are not included in the main input image I_{M}[1]. If information about the peripheral subjects included as sub tag information, convenience of search is improved.

FIGS. 5 and 6 are base on the assumption that the user has performed the operation of decreasing the angle of view in the period between the timings T_{S}[1] and T_{M}[1] so as to intend that the person as the subject of interest is enlarged in the image. In addition, it is supposed that there are trees around the person. Therefore, only a person is included as the subject in the main input image I_{M}[1] that is taken with a relatively small angle of view, while not only the person but also the trees are included as subjects in the sub input image I_{S}[1] that is taken with a relatively large angle of view. Therefore, the record control portion 16 writes “person” and “tree” in the sub tag information of the image file FL[1] based on the information Q_{S}[1].

### SECOND SPECIFIC EXAMPLE

Next, with reference to FIGS. 7 and 8, a second specific example corresponding to I_{S}[2] and I_{M}[2] will be described. In the second specific example, it is supposed that an automatic focus control (hereinafter may be referred to as an AF control) is performed prior to taking the main input image. Note that without limiting to the second specific example, the AF control can be performed prior to taking the main input image.

The AF control is performed in accordance with operation content of the shutter button 18a. The shutter button 18a supports a two-step pressing operation. If the user press the shutter button 18a slightly, the shutter button 18a becomes a half-pressed state. If the shutter button 18a is further pressed from the half-pressed state, the shutter button 18a becomes a fully-pressed state. Hereinafter, the press operation of pressing the shutter button 18a to be the half-pressed state is referred to as a half-pressing operation while the press operation of pressing the shutter button 18a to be the fully-pressed state is referred to as a fully-pressing operation. The photography control portion 13 starts the AF control responding to the half-pressing operation and controls the image sensing portion 11 to obtain the image data of the main input image responding to the fully-pressing operation performed after completion of the AF control. Note that in this specification, if “press operation” is simply referred to, it means the fully-pressing operation.

In the AF control, a position of the focus lens 31 is adjusted so that a subject in a part of the entire range of image sensing by the image sensing apparatus 1 is in focus. When this adjustment is finished and the position of the focus lens 31 is fixed, the AF control is completed. As a method of the AF control, any method including a known method can be used.

It is supposed for a specific description to adopt an AF control using a contrast detection method of a through-the-lens (TTL) type. As illustrated in FIG. 7, the photography control portion 13 or an AF score calculating portion (not shown) sets an AF evaluation region in the preview image and calculates the AF score having a value corresponding to contrast in the AF evaluation region using a high pass filter or the like. A taken image of the entire range of image sensing by the image sensing apparatus 1 is the preview image itself (i.e., an image in the entire image region of the preview image), and a taken image of the part of the image sensing range is an image in the AF evaluation region. The AF evaluation region is a part of the entire image region of the preview image. For instance, the AF evaluation region is a predetermined part region at the middle of the preview image and its vicinity. It is possible to set the AF evaluation region to include the face region positioned at the middle of the preview image and its vicinity.

The AF score increases along with an increase of contrast in the AF evaluation region. The AF score is calculated sequentially while changing the position of the focus lens 31 by a predetermined amount, so as to specify a maximum AF score among a plurality of obtained AF scores. Then, an actual position of the focus lens 31 is fixed to the position of the focus lens 31 corresponding to the maximum AF score. Thus, the AF control is completed. When the AF control is completed, the image sensing apparatus 1 reports it (by producing an electric sound or the like).

The user usually performs the following camera operation considering a characteristic of the AF control. First, the user performs the half-pressing operation in the state where the subject of interest to be in focus is positioned in the middle of the image sensing range or its vicinity. Thus, the AF control is completed in the state where the focus lens 31 is fixed to the position so that the subject of interest is in focus. After that, the image sensing apparatus 1 is moved (panning and tilting is performed) so that an actually desired composition is obtained including the subject of interest in the image sensing range. After the composition is confirmed, the fully-pressing operation is performed.

When this camera operation is performed, the preview image obtained after the half-pressing operation and before the fully-pressing operation usually include peripheral subjects of the subject of interest that are not included in the main input image. If the information about the peripheral subjects are included in the sub tag information, convenience of searching is improved.

Considering this, the following process is performed specifically. FIG. 8 is referred to. The photographing timings of the input images I_{S}[2] and I_{M}[2] are denoted by reference symbols T_{S}[2] and T_{M}[2], respectively. The photographing timing T_{S}[2] is timing before the photographing timing T_{M}[2]. After the half-pressing operation, a timing during the AF control or a timing just after the AF control is completed is handled as the photographing timing T_{S}[2], and the input image taken at the photographing timing T_{S}[2] is handled as the sub input image I_{S}[2]. Information Q_{S}[2] indicating a result of the image analysis on the sub input image I_{S}[2] is temporarily recorded in a memory (not shown) provided to the record control portion 16 or the like.

After that, when the fully-pressing operation is performed, a timing just after the fully-pressing operation is handled as the photographing timing T_{M}[2] so as to take a main input image I_{M}[2]. After taking this image, the record control portion 16 records image data and main tag information of the main input image I_{M}[2] and sub tag information based on the information Q_{S}[2] in the image file FL[2].

FIGS. 5 and 8 are based on the assumption that the user changes the composition in the period between the timings T_{S}[2] and T_{M}[2] so as to take a main input image in which the person and the vehicle are included as subjects and the person is in focus. In addition, it is assumed that the person and the trees are included in the image sensing range at the timing T_{S}[2]. Therefore, the sub input image I_{S}[1] includes not only the person but also the trees as subjects (but, the vehicle is not included). Therefore, based on the information Q_{S}[2], the record control portion 16 writes “person” and “tree” in the sub tag information of the image file FL[2].

### THIRD SPECIFIC EXAMPLE

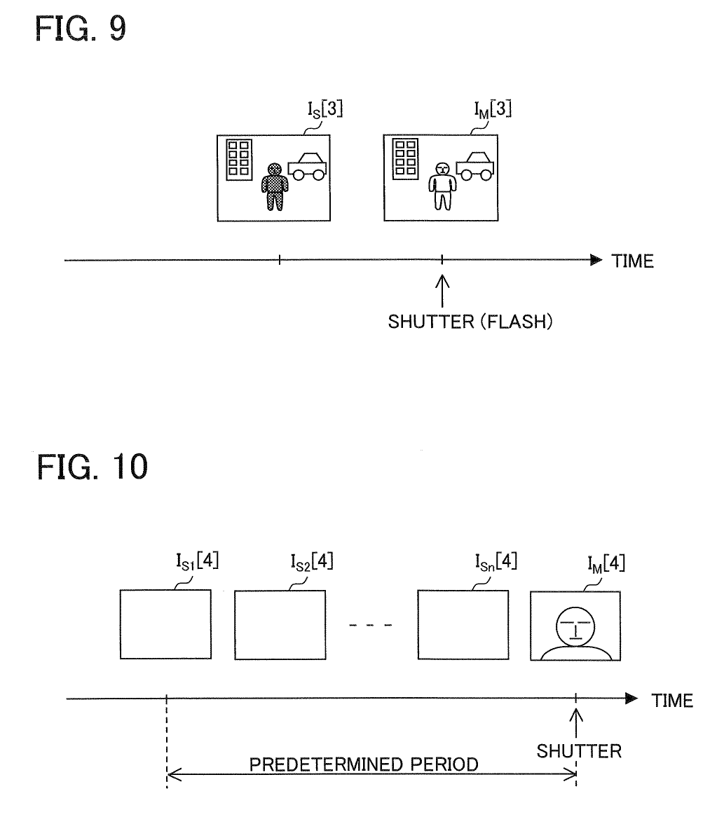

Next, with reference to FIG. 9, a third specific example corresponding to I_{S}[3] and I_{M}[3] will be described. In the third specific example, it is supposed that flash light is projected when the main input image is taken.

In the third specific example, when the press operation of the shutter button 18a is performed, a timing just after the press operation is handled as the photographing timing of the main input image I_{M}[3] so that the main input image I_{M}[3] is taken. As described above, it is supposed that flash light is projected to the subject from the light emission portion 20 when the main input image I_{M}[3] is taken (i.e., during the exposure period of the image sensor 33 for obtaining image data of the main input image I_{M}[3]).

In this case, the preview image obtained p frame periods before the main input image I_{M}[3] is handled as the sub input image I_{S}[3]. Here, p denotes an integer such as one or two, for example. When the sub input image I_{S}[3] is taken, the flash light is not projected to the subject.

Information indicating a result of the image analysis on the individual preview images obtained sequentially is temporarily recorded in a memory (not shown) provided to the record control portion 16 or the like. The record control portion 16 generates the sub tag information by reading information that has been derived based on image data of the sub input image I_{S}[3] after taking the main input image I_{M}[3], i.e., information Q_{S}[3] indicating a result of the image analysis on the sub input image I_{S}[3].

The image analysis portion 14 detects whether the sub input image is an image taken in a dark place or an image taken in a backlight situation based on the image data of the sub input image I_{S}[3], and a result of the detection is included in the information Q_{S}[3].

If only the middle of the sub input image and its vicinity where the subject of interest is to be positioned is dark and the periphery thereof is bright, it can be decided that the sub input image is an image taken in a backlight situation. More specifically, for example, if an average luminance in a predetermined image region in the middle portion of the sub input image I_{S}[3] is a predetermined reference luminance Y_{TH1} or lower and an average luminance in an image region obtained by eliminating the predetermined image region described above from the entire image region of the sub input image I_{S}[3] is a predetermined reference luminance Y_{TH2} or higher, it is decided that the sub input image is an image taken in a backlight situation. In this case, term information “backlight” is included in the sub tag information obtained from the sub input image I_{S}[3]. Here, the reference luminance Y_{TH2} is larger than the reference luminance Y_{TH1}. Note that it is possible to set a position and a size of the predetermined image region described above based on a position and a size of the face region extracted by the face detection process.

If the sub input image is dark as a whole, it can be decided that the sub input image is an image taken in a dark place. More specifically, for example, if an average luminance in the entire image region of the sub input image I_{S}[3] is a predetermined reference luminance Y_{TH3} or lower, it can be decoded that the sub input image is an image taken in a dark place. In this case, term information “dark place” is included in the sub tag information obtained from the sub input image I_{S}[3].

The record control portion 16 records the image data and the main tag information of the main input image I_{M}[3] in the image file FL[3] and records the sub tag information in which “backlight” or “dark place” is written in accordance with a result of image analysis on the sub input image I_{S}[3] in the image file FL[3]. In the example of FIG. 5, the sub tag information of the image file FL[3] includes term information “backlight”. In addition, other image analyses besides the image analysis for distinguishing “dark place” from “backlight” (such as the face detection process and the object detection process described above) are also performed on the sub input image I_{S}[3], and a result of the image analysis is also included in the sub tag information of the image file FL[3]. This example is based on the assumption that the person, the building and the vehicle are included in the image sensing range of the sub input image I_{S}[3]. Therefore, “person”, “building” and “vehicle” are also written in the sub tag information of the image file FL[3].

### FOURTH SPECIFIC EXAMPLE

Next, with reference to FIG. 10, a fourth specific example corresponding to I_{S}[4] and I_{M}[4] will be described. In the fourth specific example, as illustrated in FIG. 10, each of one or more preview images taken in a predetermined period before taking the main input image I_{M}[4] is handled as the sub input image I_{S}[4]. It is supposed that each of n preview images is handled as the sub input image I_{S}[4], and n preview images as the sub input images are denoted by symbols I_{S1}[4] to I_{Sn}[4]. Here, n denotes an integer of two or larger. It is supposed that the sub input images I_{S1}[4], I_{S2}[4], I_{S3}[4], . . . , I_{Sn}[4] are taken in this order, and that the main input image I_{M}[4] is taken just after taking the sub input image I_{Sn}[4].

The image analysis portion 14 performs the face detection process and the face recognition process on the individual preview images obtained sequentially, and a result of the face recognition process is temporarily stored for n or more preview images. Therefore, at the time point when the press operation of the shutter button 18a is performed for taking the main input image I_{M}[4], results of the face detection process and the face recognition process on the sub input images I_{S1}[4] to I_{Sn}[4] are stored. The record control portion 16 generates the sub tag information of the image file FL[4] based on the stored information. After taking the main input image I_{M}[4], the record control portion 16 records the image data and the main tag information of the main input image I_{M}[4] and the sub tag information obtained from the sub input images I_{S1}[4] to I_{Sn}[4] in the image file FL[4].

A result of the face detection process and the face recognition process on the sub input image I_{Sj}[4] includes information indicating whether or not a person is included in the sub input image I_{Sj}[4] and information indicating which one of the enrolled persons the person is if included (j is a natural number). It is supposed that the enrolled persons to be recognized by the face recognition process include different enrolled persons H_{A}, H_{B}, H_{C} and H_{D}.

If it is recognized that any one of the sub input images I_{S1}[4] to I_{Sn}[4] includes the enrolled person H_{A} as the subject, “person H_{A}” is written in the sub tag information of the image file FL[4]. Similarly, if it is recognized that any one of the sub input images I_{S1}[4] to I_{Sn}[4] includes the enrolled person H_{B} as the subject, “person H_{B}” is written in the sub tag information of the image file FL[4]. The same is true for the enrolled persons H_{C} and H_{D}.

It is supposed that it is recognized that the sub input images I_{S1}[4], I_{S2}[4] and I_{S3}[4] include the enrolled persons H_{A}, H_{B} and H_{C} as the subjects, and it is recognized that none of the sub input images I_{S1}[1] to I_{Sn}[4] includes the enrolled person H_{D} as the subject. Then, as illustrated in FIG. 5, “person H_{A}”, “person H_{B}” and “person H_{C}” are written in the sub tag information of the image file FL[4], but “person H_{D}” is not written. In addition, simple term information “person” is also written in the sub tag information of the image file FL[4]. Note that the sub input image I_{S}[4] indicated in FIG. 5 indicates one of the sub input images I_{S1}[1] to I_{Sn}[4], and it is assumed that the angle of view is decreased between timings of taking the sub input image I_{S}[4] and the main input image I_{M}[4] illustrated in FIG. 5.

In addition, if a predetermined number or more number of persons are written in the sub tag information of the image file FL[4], or if it is decided by the face detection process that one of the sub input images I_{S1}[4] to I_{Sn}[4] includes a predetermined number or more number of persons as the subjects, “group photography” may be written in the sub tag information of the image file FL[4].

Note that in any image file described above in the first to the fourth specific example, it is possible to eliminate term information overlapping with the term information included in the main tag information from the sub tag information. For instance, in the image file FL[1], it is possible not to write “person” in the sub tag information, which is written in the main tag information. In this case, only “tree” is written in the sub tag information of the image file FL[1].

### [Flow of Creating Image File]

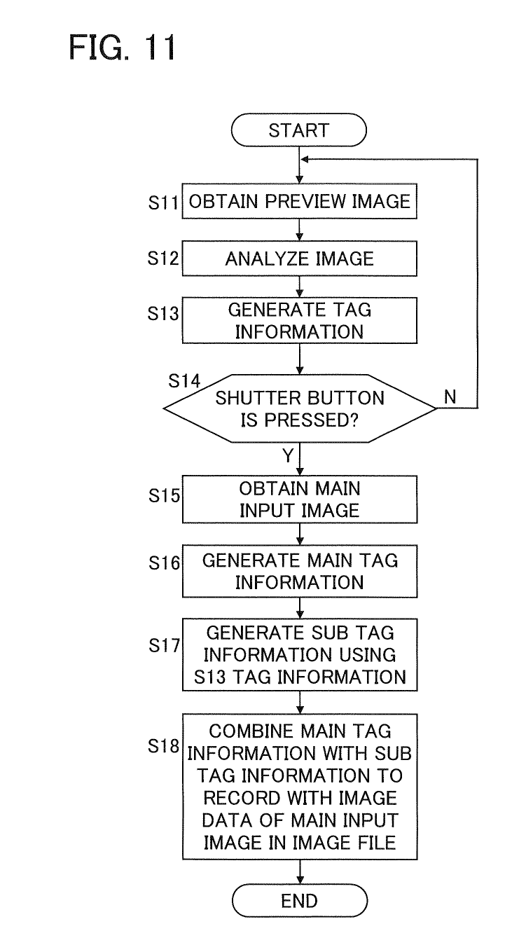

Next, with reference to FIG. 11, an operation flow of the image sensing apparatus 1 for creating the above-mentioned image file will be described. FIG. 11 is a flowchart illustrating this operation flow.

First, a preview image is obtained by the image sensing portion 11 in Step S11, the image analysis is performed on the preview image in Step S12, and tag information based on a result of the image analysis is generated in Step S13. This tag information is temporarily stored in the image sensing apparatus 1. If a preview image obtained at certain timing becomes a sub input image, tag information generated for that preview image becomes sub tag information to be recorded in the image file.

In Step S14 following Step S13, it is detected whether or not the shutter button 18a is pressed. If the shutter button 18a is pressed, the main input image is taken in Step S15 so as to obtain image data of the main input image. On the other hand, if the shutter button 18a is not pressed, the process flow goes back to Step S11 so that the process from Step S11 to Step S13 is repeated.

After the main input image is taken, generation of the main tag information based on the image data of the main input image is performed in Step S16. Further, in Step S17, sub tag information is generated from the tag information generated in Step S13. It follow the individual specific examples described above about which preview image taken at which timing works as the sub input image and which tag information of the preview image taken at which timing works as the sub tag information. After generating the sub tag information, the main tag information and the sub tag information are combined so as to be written in the image file. Then, they are recorded together with the image data of the main input image in the image file of the recording medium 15 (Step S18).

### [Search Operation in Extended Search Mode]

Next, the search operation in the extended search mode will be described. As described above, the search operation in the extended search mode is similar to that of the normal search mode. In the normal search mode, the search term is looked up from only the main tag information. In contrast, in the extended search mode, the search term is looked up from both the main tag information and the sub tag information or from only the sub tag information.

An operation in the case where the search term is looked up from both the main tag information and the sub tag information will be described. In this case, the image file that is selected as a retrieved file when only “person”, only “vehicle”, only “building”, or only “portrait” is specified as the search term is the same as that in the normal search mode. However, if “tree” is specified as the search term, no image file is selected as the retrieved file in the normal search mode while the image files FL[1] and FL[2] are selected as retrieved files in the extended search mode.

In addition, it is possible to specify a plurality of search terms in the extended search mode similarly to the normal search mode. If only “person” is simply included in the search term, all the image files FL[1] to FL[4] are selected as the retrieved file. However, if, the condition that the main tag information and sub tag information include the first search term “person” and the second search term “tree” is set as the search condition, the retrieved files are narrowed to be the image files FL[1] and FL[2]. This is useful in the case where images taken in a forest with the user as a subject need to be searched for. Further, for example, if the user remembers that an image of person is taken in a backlight situation, it is sufficient to set “person” and “backlight” as search terms. Thus, the retrieved files are narrowed to be the image file FL[3].

In the normal search mode counting on only the main tag information, this narrowing operation cannot be realized. Although this example notes only four image files for a simple description, very many image files are actually recorded in the recording medium 15. Therefore, by using the sub tag information, a desired image file can be retrieved easily.

The type of the terms to be included in the main tag information and the sub tag information are not limited to those described above, and various types of terms based on results of the image analysis can be included in the main tag information and the sub tag information. For instance, if the process of estimating gender, race and age bracket of a person is performed in the image analysis, it is possible to include the estimated gender, race and age bracket for the main input image in the main tag information or to include the estimated gender, race and age bracket for the sub input image in the sub tag information.

The above-mentioned search process based on the record data in the recording medium 15 may be realized by an electronic apparatus different from the image sensing apparatus (e.g., an image reproduction apparatus that is not shown). Note that an image sensing apparatus is one type of the electronic apparatus. In this case, the above-mentioned electronic apparatus should be provided with the display portion 17 and the image search portion 21, and the record data in the recording medium 15 in which a plurality of image files are recorded should be supplied to the image search portion 21 in the electronic apparatus. Thus, the operations similar to those in the above-mentioned normal search mode and the extended search mode are realized in the electronic apparatus.

Note that specific numeric values shown in the above description are merely examples, which can naturally be changed to various values.

In usual digital still cameras and digital video cameras, the angle of view for image sensing is usually set to the wide-end angle of view or a relatively close to the wide-end when the power is turned on. The same is true for the image sensing apparatus 1. In other words, it is possible to set the angle of view of the image sensing portion 11 to the wide-end angle of view or to be relatively close to the wide-end when the image sensing apparatus 1 is turned on. Then, the input image obtained just after the image sensing apparatus 1 is turned on (e.g., an input image obtained as the preview image) may be handled as the sub input image, and it is possible to generate the sub tag information for the main input image obtained after that, from the sub input image. The wide-end angle of view means a wide-most angle of view (i.e., a maximum angle of view) in the variable range of the angle of view of the image sensing portion 11.

In addition, the embodiment of the present invention is described above based on the assumption that the sub input image is an input image taken before the main input image, but the sub input image may be an input image taken after the main input image. Any preview image taken after the main input image (a preview image for the main input image to be obtained next after the main input image) can be handled as a sub input image. Simply, for example, a preview image of a photographing timing that is a timing a predetermined time after the photographing timing of the main input image can be handled as the sub input image.

The image sensing apparatus 1 of FIG. 1 can be constituted of hardware or a combination of hardware and software. In particular, functions of the image analysis portion 14, the record control portion 16 and the image search portion 21 can be realized by only hardware, only software, or a combination of hardware and software. The whole or a part of the functions may be described as a program, and the program may be executed by a program executing unit (e.g., a computer) so that the whole or a part of the functions can be realized.

What is claimed is:

1. An image sensing apparatus comprising:
an image sensing portion which generates image data of an image by image sensing; and
a record control portion which records image data of a main image generated by the image sensing portion together with main additional information obtained from the main image in a recording medium, wherein
the record control portion records sub additional information obtained from a sub image taken at timing different from that of the main image in the recording medium in association with the image data of the main image and the main additional information.

2. An image sensing apparatus according to claim 1, further comprising an image analysis portion which detects a specific type of subject included in a target image or detects an image feature of the target image based on image data of the target image, wherein
the record control portion includes a result of detection by the image analysis portion of the main image as the target image in the main additional information, and includes a result of detection by the image analysis portion of the sub image as the target image in the sub additional information.

3. An image sensing apparatus according to claim 1, in which if an angle of view for image sensing is changed prior to taking the main image, the record control portion uses an image taken by the image sensing portion before the change as the sub image.

4. An image sensing apparatus according to claim 1, further comprising a photography control portion which performs automatic focus control when a predetermined first operation is performed on the image sensing apparatus, and controls the image sensing portion to take the main image when a predetermined second operation is performed on the image sensing apparatus after the automatic focus control, wherein
the record control portion uses an image taken by the image sensing portion in a period between the first operation and the second operation as the sub image.

5. An image sensing apparatus according to claim 2, wherein the image analysis portion detects or recognizes a face of a person as the specific type of subject.

6. An image sensing apparatus according to claim 1, wherein if the main image is taken in the state where flash light is projected to a subject, the record control portion uses an image taken by the image sensing portion before the flash light is projected as the sub image.

7. A data structure of an image file in which image data of a main image obtained by image sensing, main additional information obtained from the main image, and sub additional information obtained from a sub image taken before the main image are associated with each other and stored.
